(19) United States
(12) Patent Application Publication
(10) Pub. No.: US 2015/0080124 A1
(43) Pub. Date: Mar. 19, 2015

(54) SYSTEM AND METHOD THAT FACILITATES HOSTING A CUSTOMIZABLE SOCIAL NETWORK DRIVEN GAMING PORTAL

(71) Applicant: SportsNuttz, LLC, Fresno, CA (US)

(72) Inventors: Cory Andersen, Fresno, CA (US); Brandon Apparcel, Fresno, CA (US)

(73) Assignee: SportsNuttz, LLC, Fresno, CA (US)

(21) Appl. No.: 14/271,261

(22) Filed: May 6, 2014

Related U.S. Application Data
(60) Provisional application No. 61/877,899, filed on Sep. 13, 2013.

(51) Int. Cl. A63F 13/00

(52) U.S. Cl. CPC A63F 13/00
USPC 463/31

(57) ABSTRACT

Aspects for facilitating hosting a customizable social network driven gaming portal are disclosed within the context of a method, apparatus, computer-readable storage medium, and computing device. In various embodiments, customization data for a game is received, a digital grid is automatically generated based on the customization data, coordinates within the digital grid are assigned to players of the game, and at least one winning coordinate within the digital grid is determined. The game may correspond to a real-world event, and a winning coordinate may correspond to an actual outcome of the event. Facilitation of other customizable social media driven games is also disclosed, including a “pick 'em” game relating to picking the most winners of a plurality of events, a “pool” game relating to multiple games for players to pick from within a particular time interval, and a “challenge” game relating to spontaneous competition between or among individuals.

### CROSS-REFERENCE TO RELATED APPLICATIONS

This application claims the benefit of U.S. Provisional Patent Application Ser. No. 61/877,899, filed Sep. 13, 2013, which is titled “SYSTEM AND METHOD THAT FACILITATES HOSTING A CUSTOMIZABLE SOCIAL NETWORK DRIVEN GAMING PORTAL” and its entire contents of which are incorporated herein by reference.

### TECHNICAL FIELD

The subject disclosure generally relates to gaming systems, and more specifically to an infrastructure that facilitates hosting a customizable social network driven gaming portal.

### BACKGROUND

By way of background concerning conventional gaming systems, it is noted that electronic systems for hosting gaming activity are often run by wealthy entities that could afford the high costs associated with such sophisticated systems. A casino, for example, may operate a sports book in which wagers from several thousand people on any of various sporting events are electronically monitored. As a result, the public is undesirably limited to the types of bets offered via these systems and the particular selection of games available. For instance, although a casino's sports book may allow patrons to place wagers on different aspects of a particular sporting event (e.g., football team with most points at halftime, basketball player with most points in first quarter, etc.), the casino will ultimately determine which of these aspects it will allow action on, and for which teams/players. Therefore, if a person wishes to place a wager on a particularly obscure aspect of a game (e.g., which hitter will strikeout first) and/or involving a lower profile team/player (e.g., a team/player from the minor leagues), it is unlikely that a casino may accommodate such a wager.

Even without the aid of electronic systems though, many people often engage in informal non-electronic gaming activity. Indeed, it is not uncommon for wagers to be placed amongst a small group of people on a particularly obscure aspect of a game (e.g., which hitter will strikeout first) and/or involving a lower profile team/player (e.g., a team/player from the minor leagues). However, tracking such wagers often involves manually logging each wager on paper, which is prone to human error, especially as the number of participants increase. Many other types of wagering games are also typically logged/tracked on paper, which are prone to human error as well (e.g., the popular game of “squares”, wherein players select squares from a numbered grid corresponding to the score of a particular game).

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with a customizable social network driven gaming portal. In one such aspect, a method is provided which includes receiving customization data corresponding to a squares game associated with an event, the customization data including desired dimensions of the squares game and desired parameters of the squares game. The method may include automating generation of a digital grid based on the customization data. The automating may comprise generating the digital grid according to the desired dimensions, and designating row values and column values according to the desired parameters, the row values corresponding to a first desired event parameter, and the column values corresponding to a second desired event parameter. The method may further include assigning coordinates within the digital grid to players of the squares game, each of the coordinates respectively corresponding to a potential outcome of the event. The method may also include determining at least one winning coordinate within the digital grid, the at least one winning coordinate corresponding to an actual outcome of the event.

In another aspect, a computer-readable storage medium that facilitates customizing a social network driven game is provided. For this embodiment, the computer-readable storage medium includes computer-readable instructions for causing at least one processor to perform various acts. Such acts may include receiving customization data corresponding to a squares game associated with an event, the customization data including desired dimensions of the squares game and desired parameters of the squares game. Such acts may include automating generation of a digital grid based on the customization data. The automating may comprise generating the digital grid according to the desired dimensions, and designating row values and column values according to the desired parameters, the row values corresponding to a first desired event parameter, and the column values corresponding to a second desired event parameter. Such acts may further include assigning coordinates within the digital grid to players of the squares game, each of the coordinates respectively corresponding to a potential outcome of the event. Such acts may also include determining at least one winning coordinate within the digital grid, the at least one winning coordinate corresponding to an actual outcome of the event.

In yet another aspect, a computing device is provided. Within such embodiment, the apparatus includes a processor configured to execute computer executable components stored in memory. The computer executable components may include a communication component, an automation component, an assignment component, and an identification component. The communication component is configured to receive customization data corresponding to a squares game associated with an event, the customization data including desired dimensions of the squares game and desired parameters of the squares game. The automation component is configured to facilitate automating generation of a digital grid based on the customization data. The automating may comprise generating the digital grid according to the desired dimensions, and designating row values and column values according to the desired parameters, the row values corresponding to a first desired event parameter, and the column values corresponding to a second desired event parameter. The assignment component is configured to assign coordinates within the digital grid to players of the squares game, each of the coordinates respectively corresponding to a potential outcome of the event. The identification component is configured to determine at least one winning coordinate within the digital grid, the at least one winning coordinate corresponding to an actual outcome of the event.

Other embodiments and various non-limiting examples, scenarios, and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates hosting a customizable social network driven gaming portal in accordance with an aspect of the subject specification;

FIG. 2 illustrates an exemplary coupling of electrical components that effectuate hosting a customizable social network driven gaming portal according to an embodiment

FIG. 3 is a flow diagram of an exemplary methodology that facilitates hosting a customizable social network driven gaming portal in accordance with an aspect of the subject specification;

FIG. 4 is a screenshot of an exemplary homepage according to an embodiment;

FIG. 5 is a screenshot of an exemplary list of selectable game types for a squares game according to an embodiment;

FIG. 6 is a screenshot of an exemplary list of selectable games for a squares game according to an embodiment;

FIG. 7 is a screenshot of an exemplary customization page for a squares game according to an embodiment;

FIG. 8 is a screenshot of an exemplary list of active games according to an embodiment;

FIG. 9 is a first screenshot of an exemplary squares game according to an embodiment;

FIG. 10 is a second screenshot of an exemplary squares game according to an embodiment;

FIG. 11 is a third screenshot of an exemplary squares game according to an embodiment;

FIG. 12 is a fourth screenshot of an exemplary squares game illustrating a menu feature according to an embodiment;

FIG. 13 illustrates a block diagram of an exemplary computing device that facilitates hosting a customizable social network driven game portal in accordance with an aspect of the present specification;

FIG. 14 illustrates an exemplary digital grid for a 10 by 10 (“10×10”) squares game according to an embodiment;

FIG. 15 illustrates several digital grids of various dimensions according to one or more embodiments;

FIG. 16 illustrates digital grids corresponding to multi-round competition between two competitors according to an embodiment;

FIG. 17 illustrates a digital grid for a 6 by 10 (“6×10”) squares game according to an embodiment;

FIG. 18 illustrates a flow diagram of an exemplary method for facilitating hosting of a customizable social network driven gaming portal, relating specifically to a customizable squares game;

FIG. 19 illustrates a flow diagram of an exemplary method for facilitating hosting of a customizable social network driven gaming portal;

FIG. 20 is a block diagram representing exemplary non-limiting networked environments in which various embodiments described herein can be implemented; and

FIG. 21 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional gaming systems. The embodiments disclosed herein are directed towards overcoming such limitations via an infrastructure that facilitates hosting a customizable social network driven gaming portal. Namely, aspects are disclosed which facilitate the impromptu hosting of any of various gaming scenarios, wherein players can be invited/added electronically.

In a first exemplary embodiment, a customizable squares game is contemplated. Within such embodiment, a customizable digital squares board can be created via an electronic portal for any sporting event/game/match (e.g., football, basketball, baseball, tennis, boxing, golf, etc.). The portal can then be further configured to electronically invite/add players to fill such squares, which may include inviting/adding players from a user's social network. For instance, the portal may be configured to electronically solicit players selected by a user, wherein contact information for the selected players can be retrieved from the user's contact list. Moreover, it should be appreciated that the portal may be configured to communicate with selected players via any of a plurality of modes including, but not limited to, short messaging service (SMS), push notifications, social media posting, and/or e-mail, wherein the contact information for the particularly desired mode can be retrieved from a user's contact list. It should be further appreciated that, in addition to soliciting players for a particular game, the portal may be configured to communicate the outcome of each game (e.g., the “winner” of the first quarter).

In another embodiment, a “pick'em” game is contemplated. Within such embodiment, a network of friends can compete to see who can pick winners better from any of a plurality of upcoming sporting events/matches/games. To this end, the portal may be configured to schedule which events/matches/games players will “pick” from, wherein such selection may be random (e.g., portal randomly picks events/matches/games) or user-based. A “knockout” format is also contemplated in which players are eliminated for inaccurate picks, wherein the last remaining player wins.

In yet another embodiment, a “pool” game is disclosed, wherein the portal is configured to select multiple games for players to pick from within any particular time interval (e.g., five football games a week, all football games in a season, etc.). A pool game may also include teams of players, wherein the team with the most number of accurate picks within a particular interval wins. Here, it should be appreciated that the networking aspect of the portal may be configured to facilitate the building of such teams.

A “challenge” game is also contemplated, which allows users to challenge each other on in any type of competition (e.g., an office weight loss challenge, a hot dog eating contest, etc.), wherein the portal is configured to solicit/track wagers from a network of friends. For instance, two friends at a bar may spontaneously challenge each other to a foot race. Here, one of the two friends (or perhaps a third friend) can utilize the portal to instantly promote the race to their network of friends (many of which may not be physically present to witness the race), wherein wagers from those friends are electronically received and memorialized into the system. The creator of the challenge game could then enter the outcome of the race via the portal, and the portal could be configured to then automatically identify the winning/losing wagers based on the outcome.

Exemplary steps for creating/hosting a given “challenge” game can therefore include the following: First, details/parameters of a particular competition are received, wherein the exemplary details/parameters may include, type of competition (e.g., fastest from group of bar patrons to receive a phone number; whether a someone could eat a number of hot peppers in a sitting, etc.) competitors involved (e.g., the particular bar patrons seeking phone numbers; the particular person eating hot peppers in a sitting, etc.), wager invitees for event (e.g., social circle of event competitors, which may be determined by a competitor's corresponding list of contacts retrieved from a social media site and/or electronic address book, for instance); Second, wager invitees are contacted, which alerts them of an active wager generated within his/her social circle; Third, the newly generated “challenge” game is generated according to the details/parameters provided, and including invitees who accepted their invite; Fourth, the game administrator inputs the outcome of the challenge (e.g., “John got the most phone #s”, “Steve ate twenty hot peppers in one minute!”, etc.); and Fifth game results are posted/disseminated (e.g., “John got the most phone #s” could be posted on the portal for participants and friends to view, and/or disseminated via SMS, e-mail, push notification, etc.).

### Exemplary Embodiments

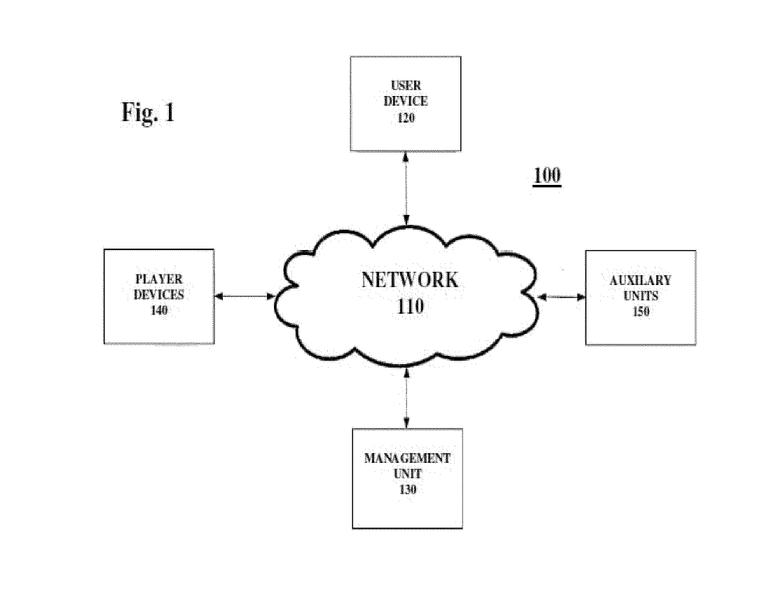

Turning now to FIG. 1, an exemplary environment that facilitates hosting a customizable social network driven gaming portal is provided according to an embodiment. As illustrated, environment 100 includes user device 120, which is coupled to management unit 130, player devices 140, and auxiliary units 150 via network 110 (e.g., the Internet). Within such embodiment, it is contemplated that user device 120 (e.g., a personal computer, mobile phone, tablet, etc.) is utilized by a user to enter customization data for a particular game (e.g., a squares game, pool game, pick'em game, challenge game, etc.) via a portal, which is then received by management unit 130. Once the customization data is received, management unit 130 can then create/manage the particularly desired game based on the data received. For instance, management unit 130 may be configured to receive sporting event updates from auxiliary units 150 (e.g., real-time score updates of a selected basketball game from a league website). It is also contemplated that auxiliary units 150 may comprise an advertisement database from which management unit 130 may strategically retrieve advertisements to display on the portal (e.g., advertisement for tickets to the selected basketball game).

In a particular embodiment, with respect to communicating with potential/actual players of the newly created game, it is contemplated that player devices 140 (respectively corresponding to these potential/actual players) have a portal application residing on it. Within such embodiment, solicitations to a game including updates thereafter are communicated via the portal application (e.g., push notification). Alternatively, or in addition to, it is contemplated that management unit 130 communicates with potential/actual players via other modalities (e.g., SMS, social media post, e-mail, etc.).

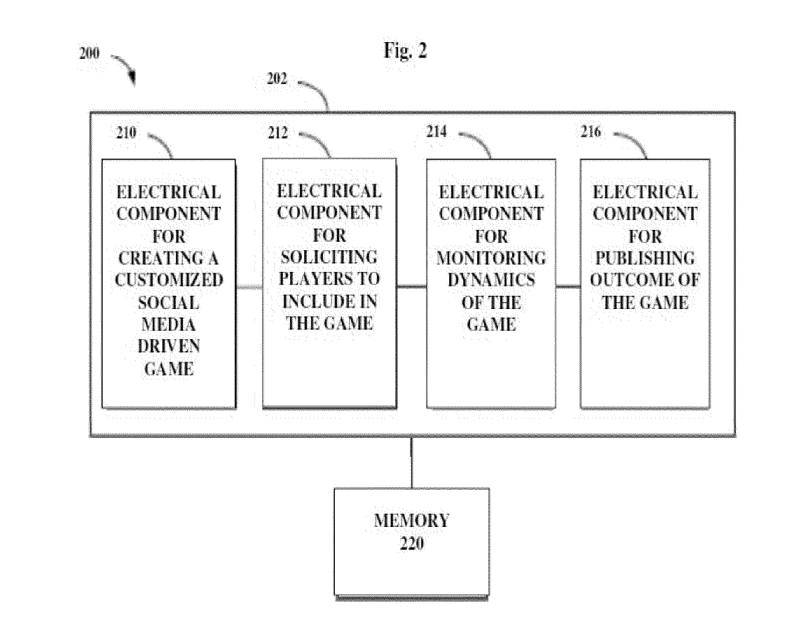

Turning to FIG. 2, illustrated is a system 200 that facilitates hosting a customizable social network driven gaming portal according to an embodiment. System 200 and/or instructions for implementing system 200 can reside within a computing device (e.g., user device 120, management unit 130, etc.), for example. As depicted, system 200 includes functional blocks that can represent functions implemented by a processor using instructions and/or data from a computer readable storage medium. System 200 includes a logical grouping 202 of electrical components that can act in conjunction. As illustrated, logical grouping 202 can include an electrical component for creating a customized social network driven game 210, as well as an electrical component for soliciting players to include in the game 212. Logical grouping 202 can also include an electrical component for monitoring dynamics of the game 214. Further, logical grouping 202 can include an electrical component for publishing an outcome of the game 216. Additionally, system 200 can include a memory 220 that retains instructions for executing functions associated with electrical components 210, 212, 214, and 216. While shown as being external to memory 220, it is to be understood that electrical components 210, 212, 214, and 216 can exist within memory 220.

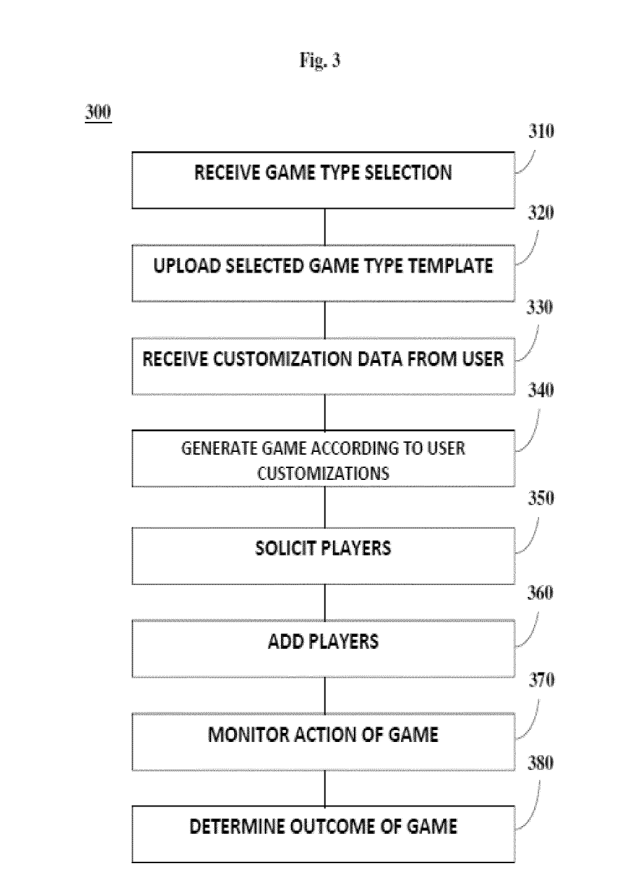

Referring next to FIG. 3, a flow chart illustrating an exemplary method to facilitate hosting a customizable social network driven gaming portal according to an embodiment is provided. As illustrated, process 300 includes a series of acts that may be performed within a computing device (e.g., user device 120, management unit 130, etc.) according to an aspect of the subject specification. For instance, process 300 may be implemented by employing a processor to execute computer executable instructions stored on a computer readable storage medium to implement the series of acts. In another embodiment, a computer-readable storage medium comprising code for causing at least one computer to implement the acts of process 300 is contemplated.

In an aspect, process 300 begins with a game type selection being received at act 310. As stated previously, such game type may include, but is not limited to, a squares game, a pick'em game, a pool game, or a challenge game. Once the game type selection is received, a game type template application corresponding to the selected game type is uploaded at act 320. For instance, a squares template application may comprise code, wherein various functional and aesthetic aspects of the squares game are defined by arguments corresponding to customization data subsequently received at act 330 (e.g., square dimensions, game title, player invitees, buy-in, etc). At act 340, the customization data is then inserted into the template, and the application is compiled to generate the customized game desired.

Process 300 then proceeds to act 350 where players identified as invitees for the game are solicited. As stated previously, such solicitation may be made via a portal application residing on a potential player's computing device (e.g., via a push notification), or any of several other modalities known in the art (e.g., SMS, social media post, e-mail, etc.). Solicited players are then added to the game at act 360 based on whether they accept their invite. In an aspect, players can continue to be added until a pre-determined deadline (e.g., a week after solicitation, five minutes for the subject sporting event, etc.).

Once the system ceases to accept players, process 300 proceeds to act 370 where the action of the game is monitored. For instance, with respect to a game involving a sporting event, the system may search/retrieve data corresponding to the particular aspect(s) of the sporting event that the game depends on (e.g., halftime score of a soccer game, pass completions of a particular quarterback, etc.). To this end, it should be noted that the administrator of the game may have to manually enter such data, if the data is unavailable. For instance, if the required data is a particularly obscure statistic (e.g., first hockey player to lose his stick) and/or if data for the particular team/player is electronically unavailable (e.g., score of a blacktop basketball game), the administrator could simply enter this data. Similarly, for a challenge game, the administrator may be required to input an outcome of the subject event (e.g., salesman A outsold salesman B).

After determining the outcome of the subject event(s), process 300 determines the outcome of the game at act 380. Moreover, the system identifies the winner(s)/loser(s) of the game and publishes those results. Similar to all other communications, the publishing of results may comprise refreshing the portal application so as to identify the winner(s)/loser(s) (e.g., identifying the winner(s)/loser(s) via a push notification, portal e-mail, page refresh, etc.), and/or any of other modality known in the art (e.g., SMS, social media post, e-mail, etc.).

### Exemplary Screenshots

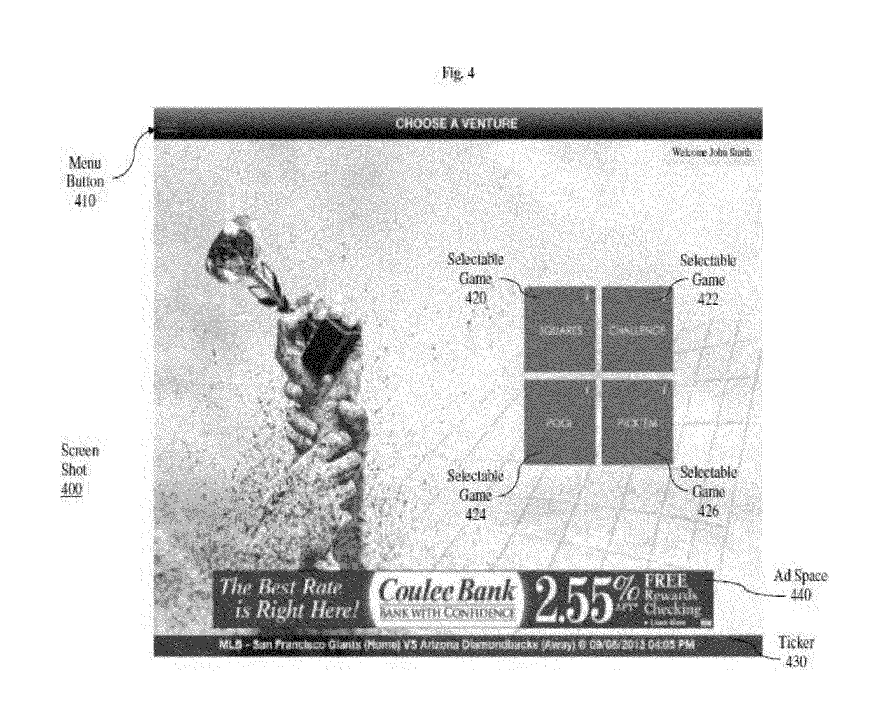

Referring next to FIGS. 4-12, a series of exemplary screenshots according to a particular tablet implementation of an embodiment is provided. Beginning with FIG. 4, a screenshot of an exemplary homepage is provided. As illustrated, screenshot 400 comprises selectable games 420, 422, 424, and 426, each of which is selectable via touchscreen. For this particular embodiment, selectable game 420 corresponds to a squares game, selectable game 422 corresponds to a challenge game, selectable game 424 corresponds to a pool game, and selectable game 426 corresponds to a pick'em game. Upon selecting any of selectable games 420, 422, 424, or 426, a sequence of steps for creating a custom game of corresponding type will begin.

As illustrated, screenshot 400 further comprises menu button which is configured to provide a plurality of navigation options (e.g., archive of previously created games, friend/buddy management, profile setting edits, etc.). Screenshot 400 also comprises ticker 430 and ad space 440, as shown. Within such embodiment, ticker 430 is configured to display a dynamic stream of continuously updated news (e.g., real-time sporting event scores/results), whereas ad space 440 is configured to display dynamic advertisements (e.g., strategic/targeted advertisements based on user activity, user demographics, location data, etc.).

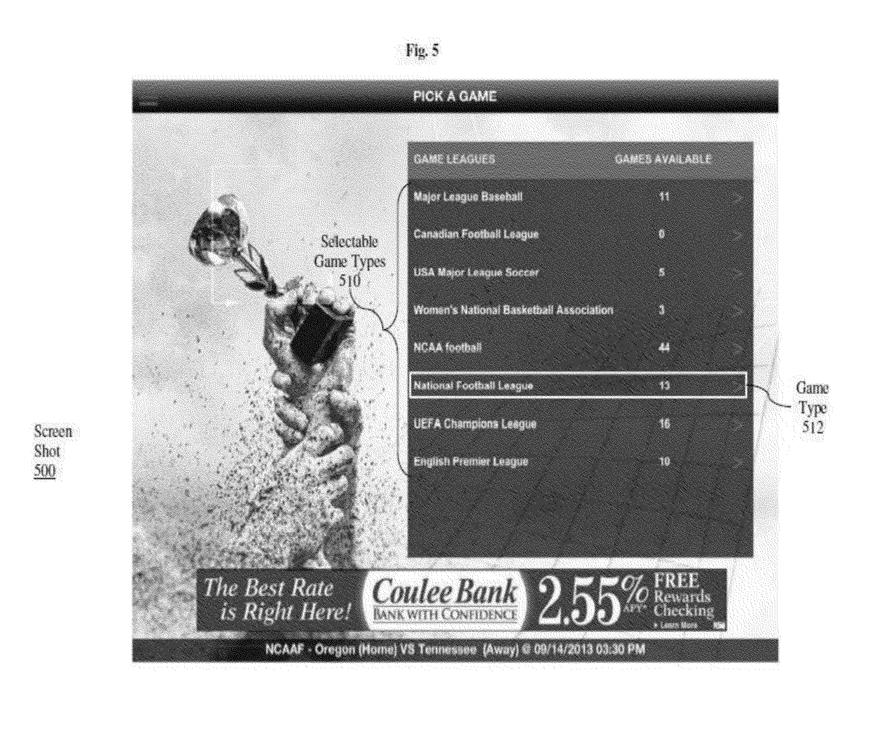

Referring next to FIG. 5, a screenshot of an exemplary list of selectable game types for a squares game is provided. Here, screenshot 500 resulted from selecting selectable game 420 in screenshot 400, which corresponds to a squares game. As illustrated, screen shot 500 comprises a plurality of selectable game types 510. Here, it should be appreciated that the displayed list of selectable game types 510 does not represent an exhaustive list of possible game types a user may select. Rather, this particular list displays the game types for sporting events in which data is readily accessible. In other embodiments, it is contemplated that a squares game may be customized for events in which data is not readily accessible, wherein such data is manually input by the administrator. For this particular example, game type 512 is selected which corresponds to National Football League games, wherein thirteen are indicated as available.

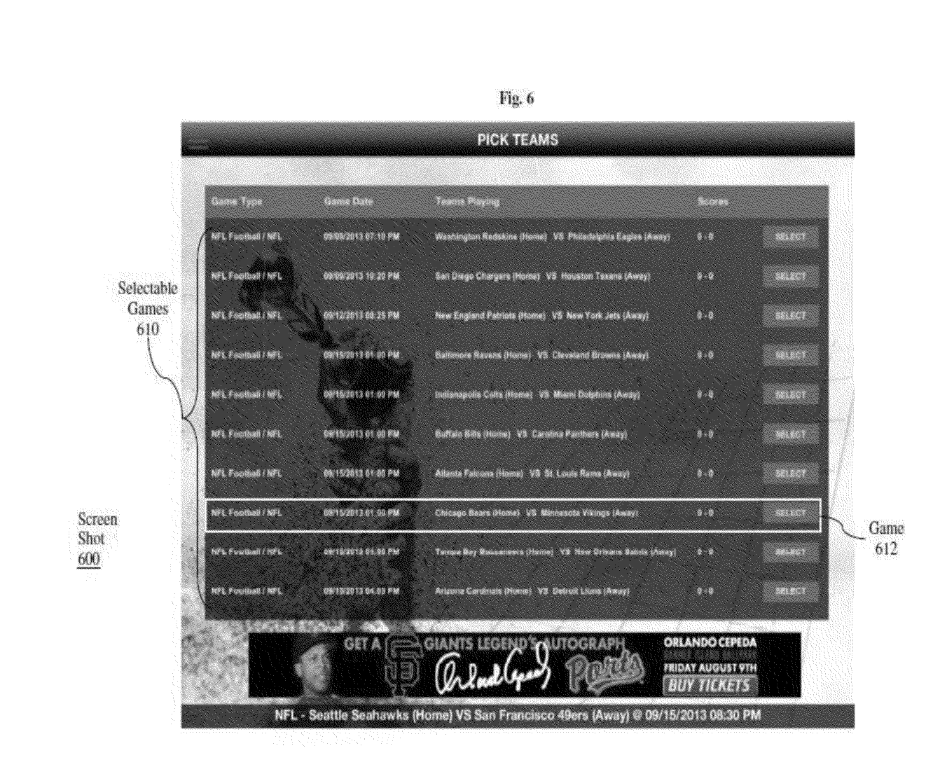

Referring next to FIG. 6, a screenshot of an exemplary list of selectable games for a squares game is provided. Because game type 512 in screenshot 500 was selected, all selectable games corresponding to game type 512 are displayed. In particular, screenshot 600 comprises selectable games 610, which correspond to the aforementioned thirteen available National Football League games (games not displayed in FIG. 6 are accessible via scroll). In this example, if a user wanted to create a squares game based on the Chicago Bears v. Minnesota Vikings game, the user would simply select game 612.

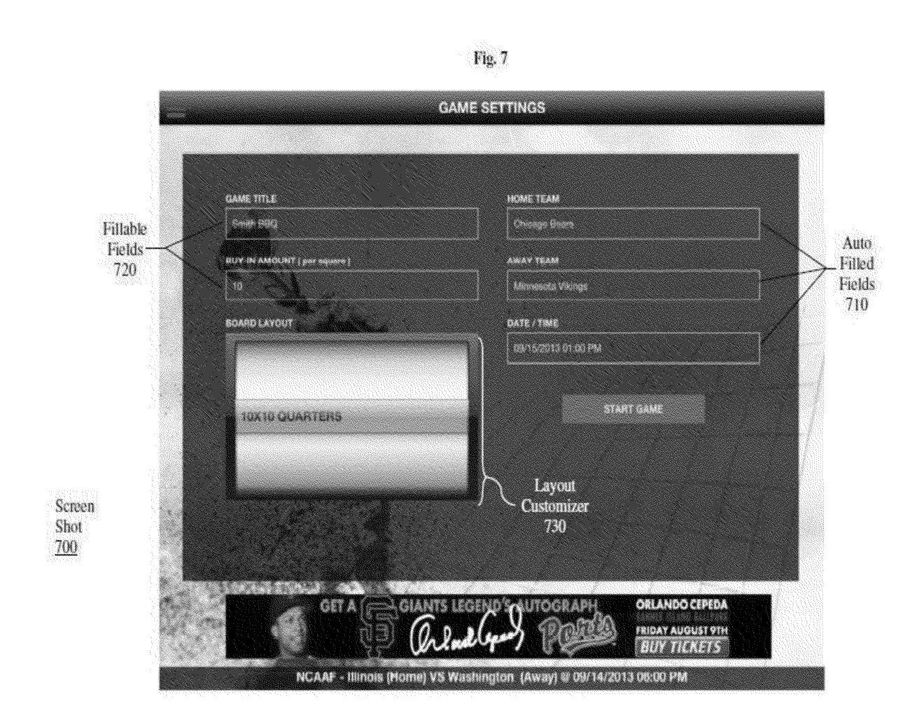

After selecting game 612 in screenshot 600, screenshot 700 in FIG. 7 is displayed, which illustrates an exemplary customization page for a Chicago Bears v. Minnesota Vikings squares game. In an aspect, screenshot 700 comprises both auto-filled fields 710 and fillable fields 720. Here, entries for auto-filled fields 710 are automatically filled once game 612 was selected in screenshot 600 (i.e., data for the home team, visitor team, and game date/time are automatically filled). As mentioned previously, if a user wishes to create a squares game based on a game not listed, the user could simply manually edit auto-filled fields 710 with the appropriate designations. As illustrated, fillable fields 720 correspond to fields that are initially displayed as empty, which require a user input. Fillable fields 720 in this example correspond to a user-defined game title (e.g., “Smith BBQ”, as shown), and a buy-in amount per square (e.g., “$10”, as shown). It should also be noted that a dimension customization tool such as layout customizer 730 may be provided, as shown. For instance, although only a “10×10 quarters” selection is shown, any of a plurality of other dimensions could be selected.

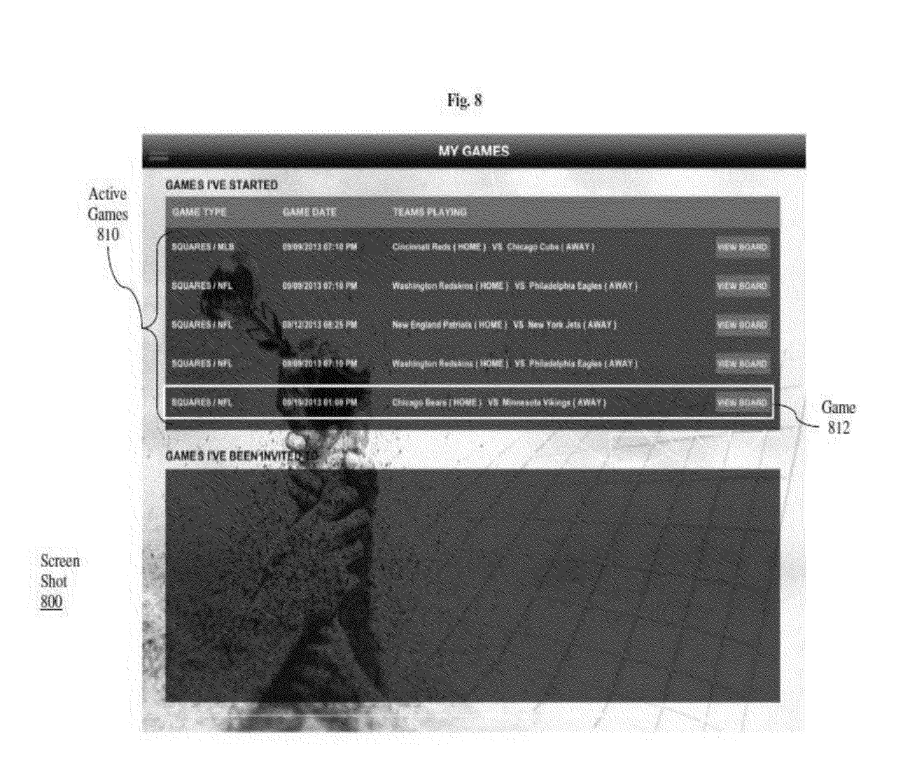

In an aspect, after the customization data has been entered via screenshot 700, a screenshot of a user's list of active games may be displayed. An exemplary list of such active games is provided in screenshot 800 illustrated in FIG. 8. As shown, screenshot 800 comprises active games 810, which includes game 812 corresponding to the newly created Chicago Bears v. Minnesota Vikings squares game. Here, although squares games are mostly popular with football games, an aspect contemplated and disclosed herein is that the dimensions of a squares game may be automatically customized to accommodate any of a plurality of sporting events (e.g., the displayed Cincinnati Reds v. Chicago Cubs squares game, wherein baseball innings would replace football quarters). Other transformations are also contemplated, such as boxing (rounds would replace football quarters), golf (holes would replace football quarters), etc.

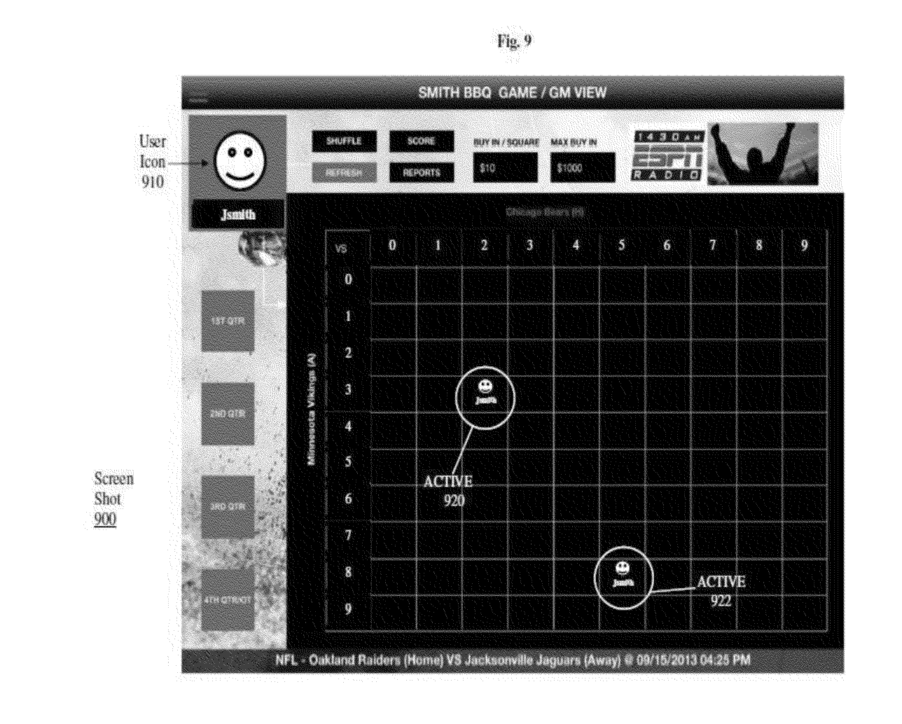

Referring next to FIGS. 9-12, an exemplary progression of the newly created Chicago Bears v. Minnesota Vikings squares game is provided. In FIG. 9, a first screenshot of such exemplary progression is provided, wherein screenshot 900 comprises a number grid corresponding to a plurality of selectable squares. As illustrated, the “Smith BBQ” title is displayed, as well as the “$10 buy-in” that was entered. In a particular aspect, screenshot 900 also includes user icon 910 which may include an image desired by the particular user (e.g., a photo of himself/herself). Once a square is claimed by a player, the icon of the corresponding user is displayed on the claimed square. Here, for example, because squares 920 and 922 were claimed by “Jsmith”, the icon associated with “Jsmith” is now superimposed onto squares 920 and 922. Moreover, each of the players for this particular game can now see that squares 920 and 922 are claimed by “Jsmith”.

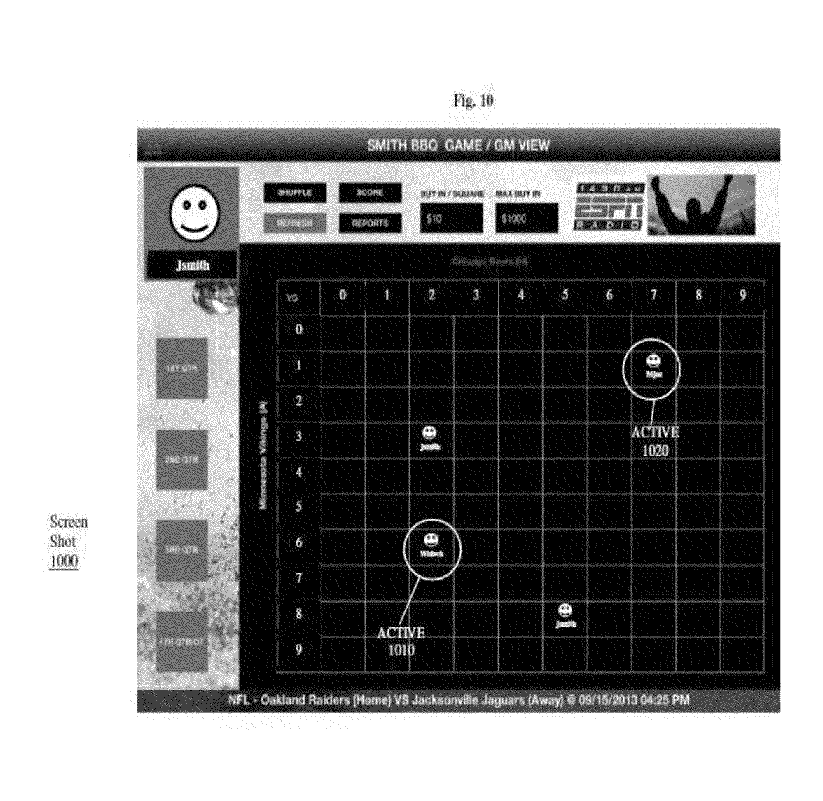

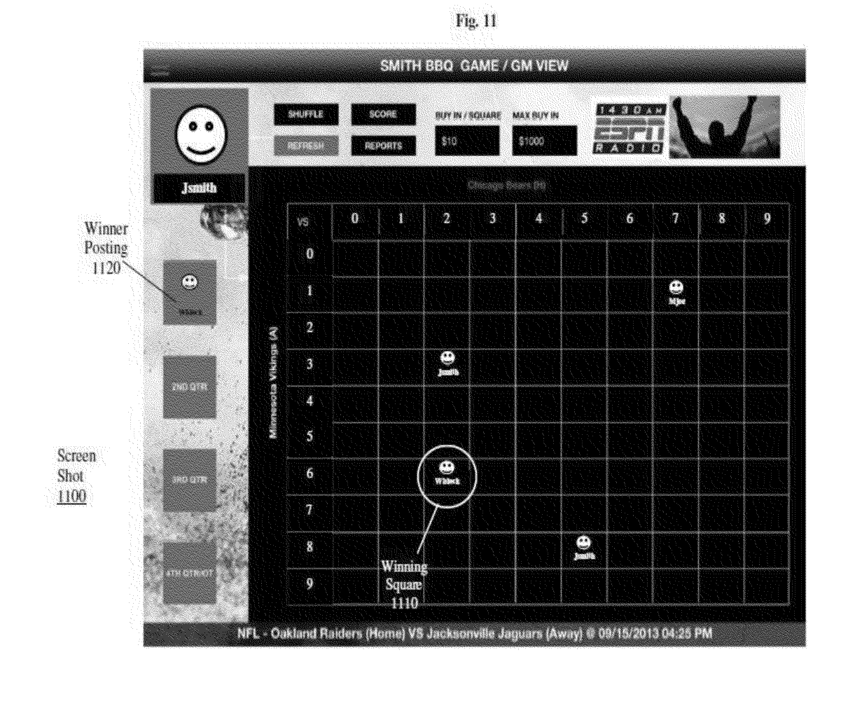

Next, in FIG. 10, screenshot 1000 illustrates a progression of screenshot 900 after two other squares are claimed. In particular, square 1010 is now claimed by “Wblack”, whereas square 1020 is now claimed by “Mjoe”. FIG. 11 then illustrates a subsequent screenshot in which a winner is identified. As shown in screenshot 1100, because winning square 1110 corresponds to “Wblack”, winning post 1120 now shows the “Wblack” icon indicating that “Wblack” has won the first quarter of this squares game.

After a winner has been identified, it should be appreciated that the announcing/publishing of such winner can be made in various ways. For instance, in addition to displaying the winner's icon (e.g., winning post 1120), players can design custom banter which can then be heard/seen/read by other players (e.g., an avatar animation of a touchdown dance, an audio clip of a particular song, etc.). This custom banter can be created and uploaded by a user upon creating/editing their profile.

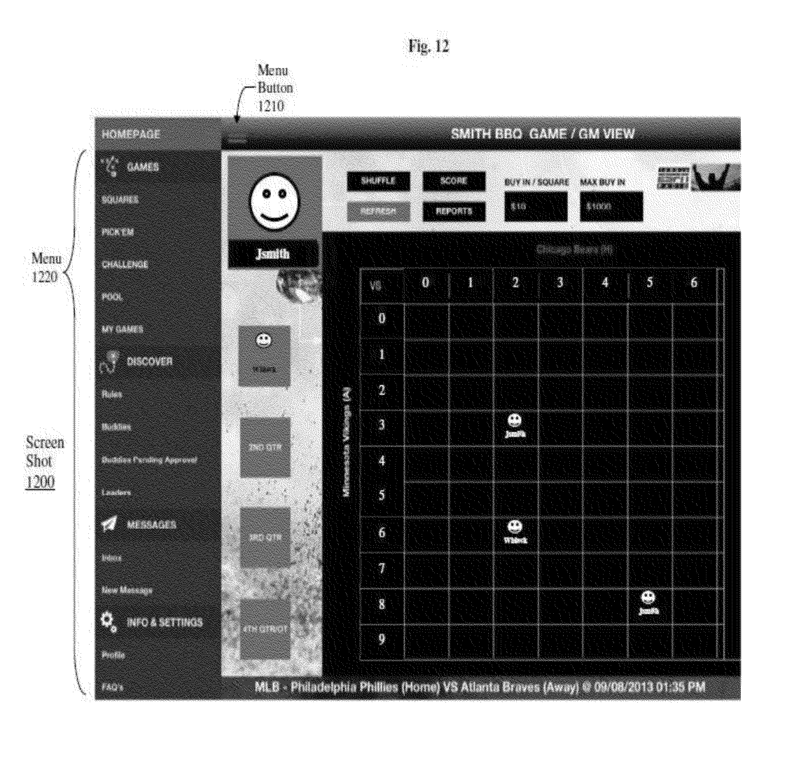

Once a user wishes to navigate away from a particular screen, a menu button could be selected. In FIG. 12, for example, screenshot 1200 is provided which illustrates an exemplary menu feature according to an embodiment. For this particular embodiment, it is contemplated that selecting menu button 1210 will cause menu 1220 to appear, as shown, wherein a user could then select any of a plurality of navigation options. For instance, a user could navigate back to previously created games (e.g., a previously created squares game, pool game, challenge game, etc.). A user could also manage his/her “buddy” list, and/or update their profile setting (e.g., change their user icon, create a custom banter, etc.).

It should be noted that, although a tablet implementation is described in connection with FIGS. 4-12, one of ordinary skill would appreciate that any of a plurality of analogous implementations also fall within the scope and spirit of the disclosed subject matter. For instance, a casino implementation is contemplated in which devices associated with the casino are linked to the infrastructure disclosed herein. Moreover, it is contemplated that aspects of a gaming portal (e.g, a digital customizable squares board), as disclosed herein, can be viewed and/or generated via such devices (e.g., touch screen point-of-sale device, casino big screen, etc.), wherein the infrastructure for hosting/managing the system may be operated/managed in-house or outsourced, and be hosted/managed via any of a plurality of software platforms.

### Exemplary Gaming Portal Components

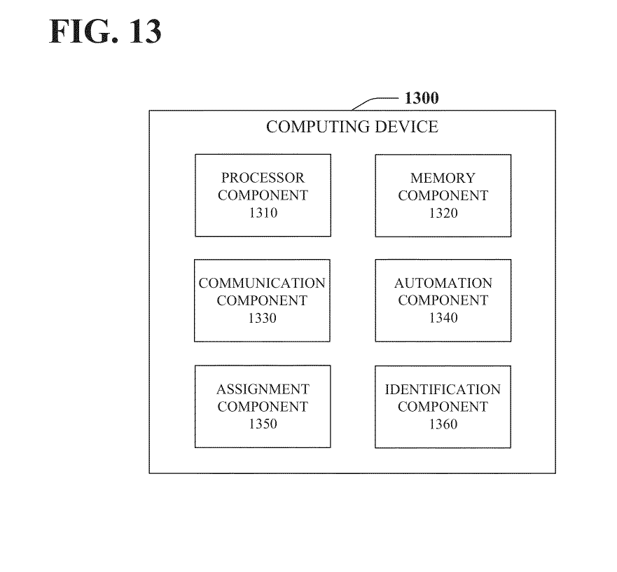

FIG. 13 shows a block diagram of an exemplary computing device 1300 which facilitates hosting a customizable social network driven gaming portal. As shown in FIG. 13, computing device 1300 may include a processor component 1310, a memory component 1320, a communication component 1330, an automation component 1340, an assignment component 1350, and an identification component 1360. Components 1310-1360 may reside together in a single location or separately in different locations in various combinations, including, for example, a configuration in which any of the aforementioned components reside in a cloud. For instance, with reference to FIG. 1, it is contemplated that these components may reside, alone or in combination, in any of user device 120, management unit 130, player devices 140, and/or auxiliary units 150.

In one aspect, processor component 1310 is configured to execute computer-readable instructions related to performing any of a plurality of functions. Processor component 1310 can be a single processor or a plurality of processors which analyze and/or generate information utilized by memory component 1320, communication component 1330, automation component 1340, assignment component 1350, and/or identification component 1360. Additionally or alternatively, processor component 1310 may be configured to control one or more components of computing device 1300.

In another aspect, memory component 1320 is coupled to processor component 1310 and configured to store computer-readable instructions executed by processor component 1310. Memory component 1320 may also be configured to store any of a plurality of other types of data including data generated by any of communication component 1330, automation component 1340, assignment component 1350, and/or identification component 1360. Memory component 1320 can be configured in a number of different configurations, including as random access memory, battery-backed memory, Solid State memory, hard disk, magnetic tape, etc. Various features can also be implemented upon memory component 1320, such as compression and automatic back up (e.g., use of a Redundant Array of Independent Drives configuration). In one aspect, the memory may be located on a network, such as a “cloud storage” solution.

Communication component 1330 may be used to interface computing device 1300 with external entities. For example, communication component 1330 may be configured to receive and/or transmit data via network 110 (see FIG. 1). Communication component 1330 may be configured to receive customization data corresponding to a squares game associated with an event. The customization data may include desired dimensions of a squares game and desired parameters of the squares game. Customization data may include a title of the event upon which the squares game is based, the type of event (e.g., “football game” or “basketball game”), a buy-in amount (e.g., $10), a player pool, or other data.

In an aspect, communication component 1330 may be configured to solicit a pool of candidate players to participate in the squares game. Such solicitation or invitation may occur via push notification, SMS, e-mail, or other methods.

In another aspect, communication component 1330 may be configured to notify the players of corresponding coordinate assignments prior to the event. Such notification may be triggered by the closing of a window of time during which invitations are accepted, and/or may occur at the start of the event or at a predetermined (or customized) time before the event (e.g., 5 minutes before the start of the event). Such notification may occur via push notification, SMS, e-mail, or other methods.

In another aspect, communication component 1330 may be configured to disseminate game results to the players, e.g., during and/or after the event. Such results may include winners with regard to portions of the event (e.g., “John won first quarter”) or overall game results. Such dissemination may occur via push notification, SMS, e-mail, or other methods.

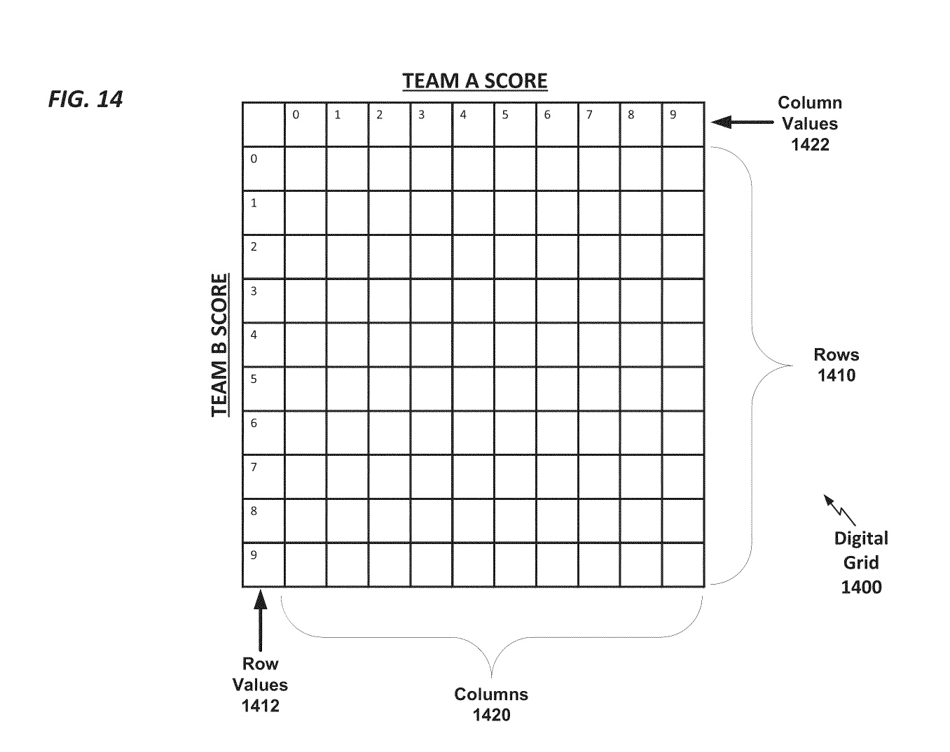

Referring still to FIG. 13, automation component 1340 may be configured to facilitate automating generation of a digital grid based on customization data received by communication component 1330. Automation component 1340 may generate the digital grid according to the desired dimensions and desired parameters of the customization data, including designating row values corresponding to a first desired event parameter, and designating column values corresponding to a second desired event parameter. FIGS. 14-17 (discussed in greater detail below) show exemplary digital grids which may be generated by automation component 1340.

Assignment component 1350 may be configured to assign coordinates within the digital grid generated by automation component 1340. Assignment component 1350 may assign one or more coordinates to each of the players of the squares game. Each coordinate may correspond to a potential outcome of the event (e.g., the real-world event upon which the game is based).

Assignment component 1350 may be configured to assign coordinates to players based upon input of players' choices (e.g., via communication component 1330) and/or to randomly assign coordinates to players. For example, after players have made choices of coordinates, assignment component 1350 may randomly assign some or all of the remaining coordinates to the players (or to other players who have not made choices). Additionally, a player may choose to be assigned a random coordinate, in which case assignment component 1350 may assign a randomly selected coordinate to that player.

Identification component 1360 may be configured to determine at least one winning coordinate within the digital grid. The winning coordinate(s) may correspond to an actual outcome of the event. Identification component 1360 may be further configured to determine and/or identify which player(s) have won the game (or a portion thereof), for example, by identifying the player to which a winning coordinate was assigned by assignment component 1350.

### Exemplary Squares Game Embodiments

FIG. 14 shows an exemplary 10 by 10 (“10×10”) digital grid 1400 of a squares game according to the present specification. Digital grid 1400 may have a number of rows 1410, a series of row values 1412, a number of columns 1420, and a series of column values 1422. As shown in FIG. 14, digital grid 1400 may have ten rows and ten columns, wherein the rows and columns correspond to integers 0-9. Column values 1422 may correspond to a potential score of a first team (e.g., Team A), and row values 1412 may correspond to a potential score of a second team (e.g., Team B).

Digital grid 1400 as shown in FIG. 14 may be ideal for a head-to-head competition between two teams in a typically low-scoring sporting event (e.g., soccer or hockey). However, in an alternative arrangement, digital grid 1400 corresponds to a single team's score (e.g., in a sporting event with typically double-digit scores, such as American football). In this arrangement, row values 1412 may correspond to a first digit of a team's score, and column values 1422 may correspond to a second digit of the team's score. Thus, if Team A's score is “53”, a winning coordinate would be located at row value “5” and column value “3”. If Team A's score is “8”, then a winning coordinate would be located at row value “0” and column value “8”. In this example, a second digital grid may be simultaneously created and utilized for the opposing team's score (e.g., Team B).

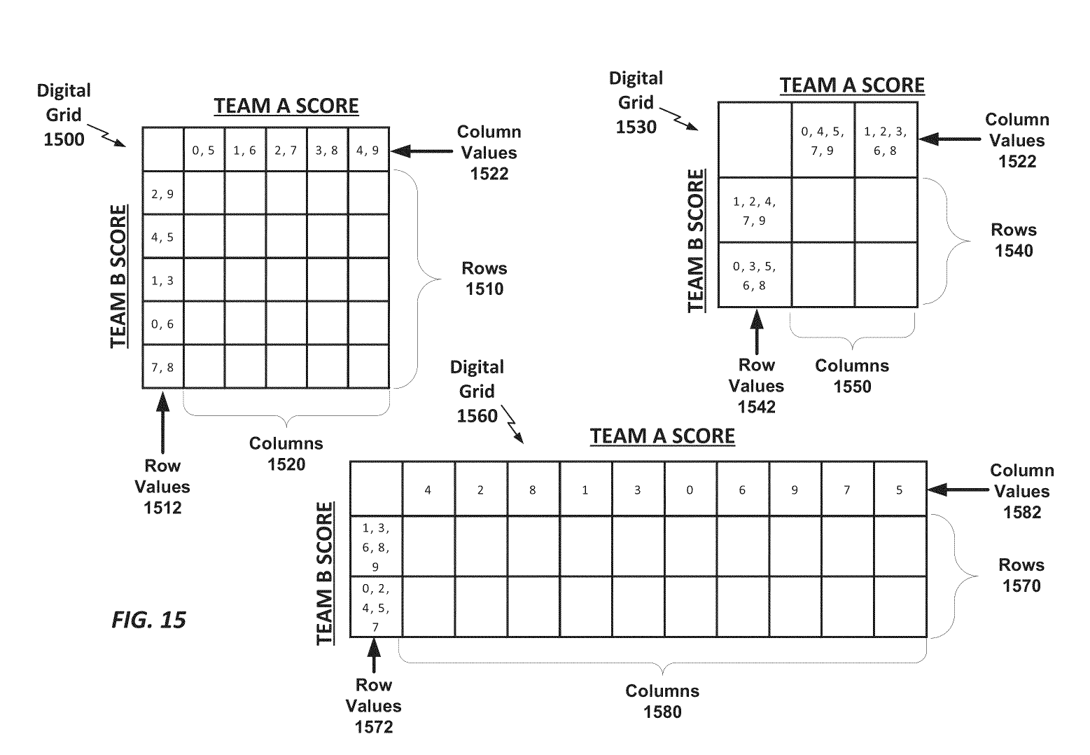

FIG. 15 shows three exemplary digital grids 1500, 1530 and 1560. Each digital grid comprises different combinations of rows and columns, and, consequently, different numbers of squares. Digital grids 1500, 1530 and 1560, having fewer squares than the digital grid 1400 of FIG. 14, could be utilized when there are a small number of players, in order to reduce the instance of empty or unselected squares.

Digital grid 1500 illustrates a 5 by 5 (“5×5”) digital grid of a squares game in which there are five rows 1510 and five columns 1520, resulting in an odd number of playable squares (25 squares). Column values 1522 may each comprise two possible scores of a first team (e.g., Team A). Row values 1512 may each comprise two possible scores of an opposing second team (e.g., Team B). Consequently, each square of digital grid 1500 may represent four possible outcomes of the event (e.g., the sporting event between Team A and Team B). Thus, in digital grid 1500, the square in the first row and first column would be a winning square for any of the following scores between Team A and Team B: 0-2, 0-9, 5-2, 5-9.

Digital grid 1530 illustrates a 2 by 2 (“2×2”) digital grid of a squares game in which there are two rows 1540 and two columns 1550. Column values 1552 may each comprise five possible scores of a first team (e.g., Team A). Row values 1542 may each comprise five possible scores of a second team (e.g., Team B). Consequently, each square of digital grid 1530 may represent twenty-five possible outcomes (i.e., one-fourth of all possible outcomes). Any combination of five digits from 0 through 9 is possible for a row value 1542 or column value 1552. For example, digital grid 1530 shows a first row corresponding to scores of 1, 2, 4, 7 and 9 for Team B, and a second row corresponding to the remaining possible scores of 0, 3, 5, 6, 8 for Team B.

In one aspect, row values 1542 are divided into odd numbers for the first row (e.g., 1, 3, 5, 7, 9) and even numbers for the second row (e.g., 0, 2, 4, 6, 8). Column values 1552 may be similarly divided. In another aspect, the row values 1542 and column values 1552 are selected at random, or selected by the creator of the game.

Digital grid 1560 illustrates a 2 by 10 (“2×10”) digital grid of a squares game in which there are two rows 1570 and ten columns 1580. Column values 1582 may each correspond to a single possible score of a first team (e.g., Team A). Row values 1572 may each comprise five possible scores of a second team (e.g., Team B). Consequently, each square of digital grid 1560 may represent five possible outcomes of the event.

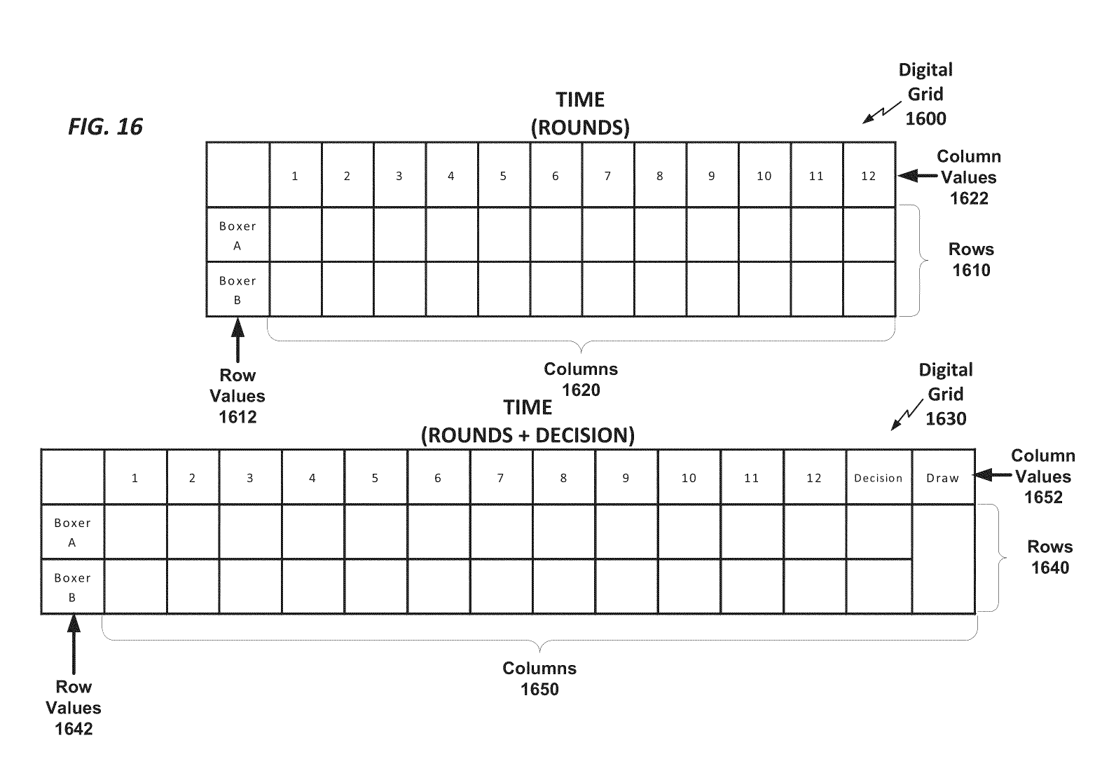

FIG. 16 shows digital grids 1600 and 1630 for squares games based upon a competition between two entities having multiple rounds (e.g., a boxing match). As shown in FIG. 16, digital grid 1600 may have two rows 1610 whose row values 1612 correspond to two competitors (e.g., Boxer A and Boxer B). Digital grid 1600 may have twelve columns 1620 whose column values 1622 correspond to the rounds of the competition (e.g., Round 1, Round 2, Round 3, etc.). Therefore, if Boxer A wins Round 3 of the competition, then a square corresponding to the first row and third column would be a winning square.

The number of rounds may correspond to a timing aspect of the event, the timing aspect being part of a first desired event parameter as part of the customization data. Boxers A and B may correspond to first and second entities identified as part of a second desired event parameter as part of the customization data.

Of course, games based upon a lesser or greater number of rounds are contemplated, as well as games having more than two competitors or a single “competitor”. Indeed, a single competitor game could occur when only one competitor exists or only one competitor is of interest (e.g., “number of successful free throws by a basketball player”, or “number of successful passes by a football quarterback”). Moreover, squares games are contemplated in which the event comprises the performance of a single competitor in a sporting event, wherein at least one of the row values or the column values corresponds to a statistical aspect of the single competitor's performance in the sporting event

Digital grid 1630 may have two rows 1640 whose row values 1642 correspond to two competitors (e.g., Boxer A and Boxer B). Digital grid 1630 may have twelve columns 1650 whose column values 1652 correspond to the rounds of the competition (e.g., Round 1, Round 2, Round 3, etc.). However, digital grid 1630 may also include additional column values 1652 entitled “Decision” and “Draw”. The “Decision” column may correspond to a winner of the competition, and thus may include a square for each competitor (e.g., a square for Boxer A, and a square for Boxer B). The “Draw” column may correspond to a draw or a tie between the competitors, and therefore may have only a single square therein (resulting in an odd number of squares). Instead of a single “Decision” column, multiple columns may be provided to correspond to: winner by knockout, split decision, majority decision, and/or unanimous decision.

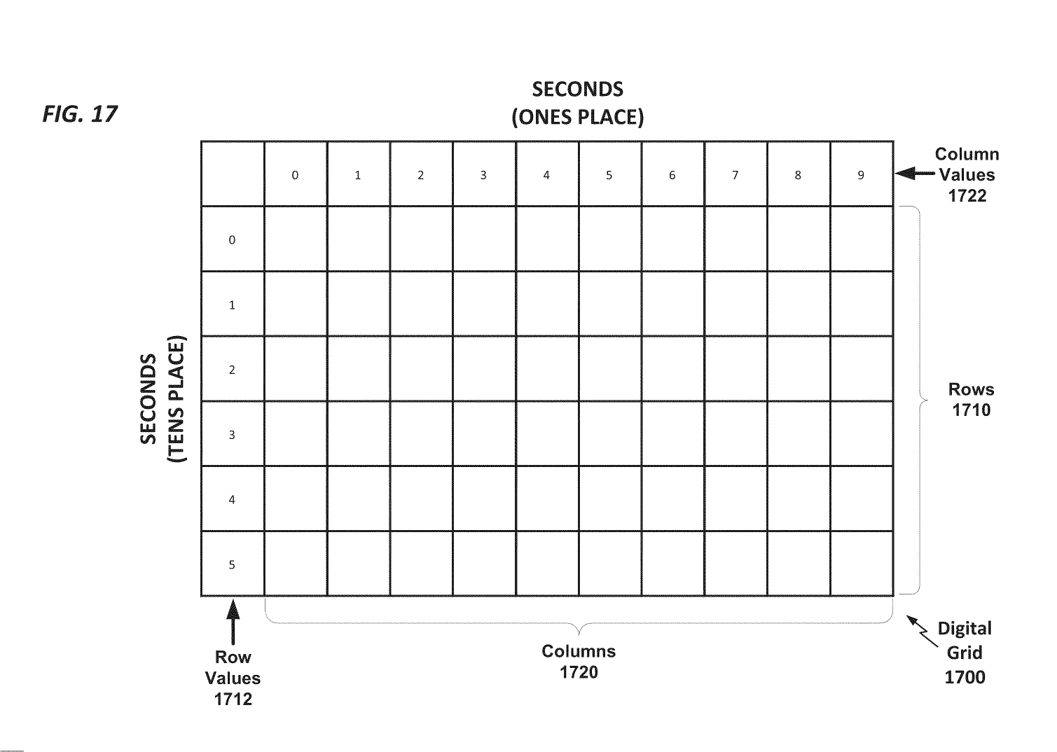

FIG. 17 shows an exemplary 6 by 10 (“6×10”) digital grid 1700 of a squares game based upon the duration of time of an event. For example, a squares game may involve guessing or predicting the length of time of an event or an aspect of the event (e.g., between 0 to 59 seconds). As shown in FIG. 17, rows 1710 may correspond to the tens place of the number of seconds, and columns 1720 may correspond to the ones place of the number of seconds. Thus, row values 1712 may range from 0 to 5, and column values 1722 may range from 0-9. This type of squares game, for example, could be used by players to wager upon the duration of time before a boxer achieves a knockout, or the amount of time it takes for a team to score their first point(s) in a basketball game.

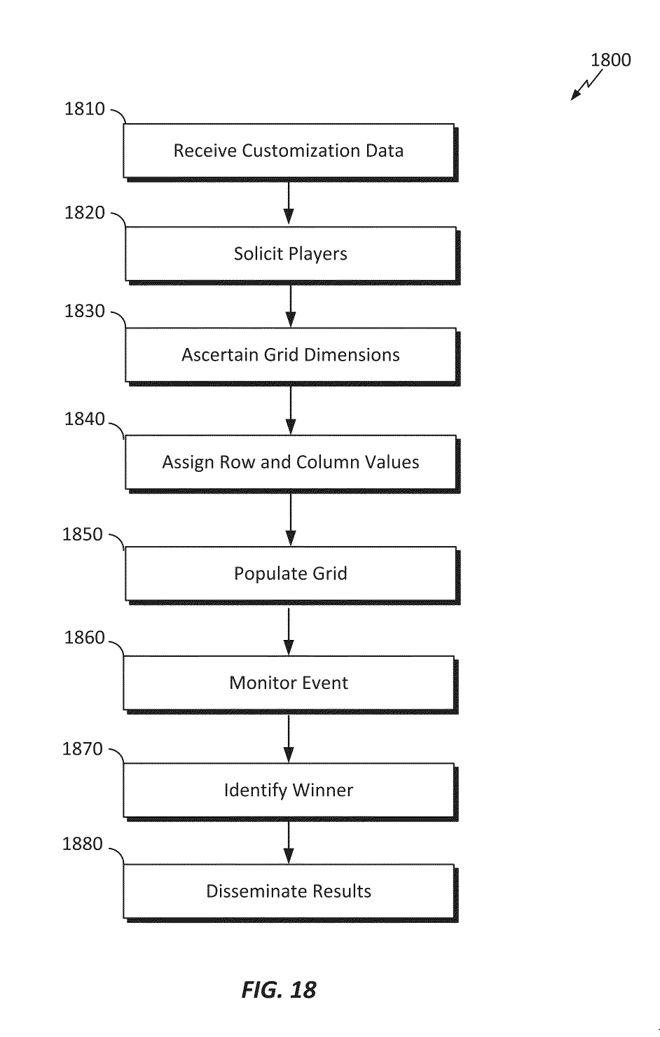

FIG. 18 shows a flow chart illustrating an exemplary method for facilitating hosting a customizable social network driven gaming portal. As illustrated, process 1800 includes a series of acts that may be performed within a computing device according to an aspect of the subject specification. For instance, process 1800 may be implemented by employing a processor to execute computer executable instructions stored on a computer readable storage medium to implement the series of acts. In another embodiment, a computer-readable storage medium comprising code for causing at least one computer to implement the acts of process 1800 are contemplated.

As illustrated in FIG. 18, process 1800 may include receiving customization data at 1810, soliciting players at 1820, ascertaining grid dimensions at 1830, assigning row and column values at 1840, populating the grid at 1850, monitoring the event at 1860, identifying a winner at 1870, and may end with disseminating results at 1880.

Receiving customization data 1810 may include receiving data from user device 120 through network 110 (see FIG. 1) to create a customizable digital squares board for any sporting event/game/match (e.g., football, basketball, baseball, tennis, boxing, golf, etc.). Soliciting players 1820 may include electronically inviting players via network 110 to fill such squares, wherein such invitations may be sent to the players' devices 140.

Ascertaining grid dimensions 1830 may include determining the number of rows and columns of the squares game for which the customization data was received at 1810. Ascertaining grid dimensions at 1830 may be performed by automation component 1340 (see FIG. 13). Assigning row and column values 1840 may include assigning single or multiple values to each row value and/or column value, depending on the grid dimensions ascertained at 1830 and the customization data received at 1810. Assigning the row and column values at 1840 may be performed by assignment component 1350 (see FIG. 13).

Populating the grid at 1850 may include receiving (or utilizing previously-received) players' selections of squares (e.g., one or more squares selected by each player), and associating the selected squares with the corresponding players. However, as explained above with respect to assignment component 1350 (FIG. 13), squares in the grid may be fully or partially populated at random. Populating the grid 1850 may also include indicating when a maximum number of coordinate assignments has been reached (e.g., all possible coordinates, or only a designated portion thereof).

Referring still to FIG. 18, monitoring the event 1860 may involve management unit 130 checking an auxiliary unit 150 over network 110 (see FIG. 1) for an update to the event upon which the squares game is based. Auxiliary unit 150 may represent a third party reporting entity (e.g., ESPN, NFL, MLB, etc.) such that winning squares may be automatically identified. Alternatively, monitoring the event 1860 may involve receiving input from the creator of the game regarding the event. Monitoring the event 1860 may involve monitoring a number of coordinates assigned to the players.

Identifying a winner 1870 may include identifying which square (if any) corresponds to a result of the event being monitored at 1860 (e.g., identifying a “winning square”). Identifying a winner 1870 may further include identifying which player (if any) is associated with the winning square. Identifying a winner 1870 may be performed by identification component 1360 (see FIG. 13).

Disseminating results 1880 may include publishing information at a common location (e.g., website) and/or sending notifications to user and/or player devices regarding the winner(s)/loser(s) of a game as identified at 1870. For example, disseminating results 1880 may comprise notifying user device 120 and/or player devices 140 via network 110 (see FIG. 1). Similar to other communications described herein, the publishing of results may comprise refreshing the portal application so as to identify the winner(s)/loser(s) via a push notification, portal e-mail, page refresh, etc.), and/or any of other modalities known in the art (e.g., SMS, social media post, e-mail, etc.).

### Additional Customizable Game Embodiments

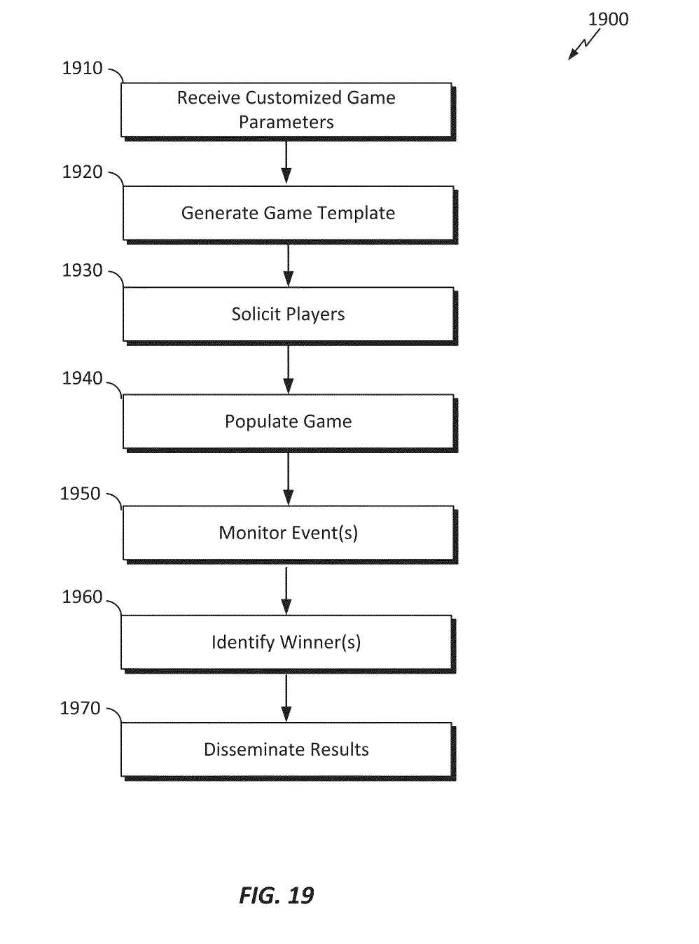

It should be appreciated that exemplary computing device 1300 may also be configured to facilitate customizing any of a plurality of other social media driven games including, for example, pick'em games, pool games, and challenge games. Exemplary implementations of each are provided below with reference to the flow diagram illustrated in FIG. 19. Similar to process 1800, process 1900 includes a series of acts that may be performed within a computing device (e.g., computing device 1300) according to an aspect of the subject specification. For instance, process 1900 may be implemented by employing a processor to execute computer executable instructions stored on a computer readable storage medium to implement the series of acts. In another embodiment, a computer-readable storage medium comprising code for causing at least one computer to implement the acts of process 1900 are contemplated.

In an aspect of the disclosure, a customized pick'em game may be defined as a social media driven game in which at least two players predict the outcome of a single event. For instance, a user may wish to create a customized pick'em game where players of the pick'em game predict the outcome of a particular football game (e.g., “Raiders v. Broncos”). For such scenario, the user may begin by entering the customized parameters of the pick'em game, wherein such parameters are received by computing device 1300 via communication component 1330, at act 1910. Here, such parameters may include a selection of the football game as the event (e.g., from a pull-down menu), a list of players to invite (e.g., from a contact list), wager, etc.

Once the customized parameters for the game are received, automation component 1340 may be configured to generate a customized template for the pick'em game, at act 1920. To this end, automation component 1340 may be configured to retrieve a generic template from a database, which is then modified according to the custom parameters received at act 1910.

Next, at act 1930, communication component 1330 is configured to solicit players for the pick'em game according to the parameters received at act 1910. For instance, in a particular embodiment, the user may wish to play this pick'em game against only one other player. In a football game scenario, for example, the user may be a “Raider” fan who solicits a particular friend who is a “Bronco” fan. Within such solicitation, the friend may receive an indication that the user is “picking” the Raiders to win this particular game, wherein the friend is then asked to accept/reject the solicitation. In some aspects, the solicitation may further include a spread for the game (e.g., “I'm taking the Raiders −3 for $100”). In another embodiment, rather than soliciting a single player, communication component 1330 is configured to solicit a plurality of players (i.e., a $100 wager on the Raiders with multiple people).

After sending all the desired solicitations, process 1900 continues to act 1940 where automation component 1340 may be configured to populate the pick'em game according to the players who accept the solicitation. Namely, automation component 1340 may be configured to keep a log that identifies which players are participating. Assignment component 1350 could then be used to track each wager by assigning a “wager value” to each participating player.

At act 1950, automation component 1340 may be configured to monitor the football game which may comprise retrieving updates from external sources (e.g., auxiliary unit 150 over network 110). As stated previously, auxiliary unit 150 may represent a third party reporting entity (e.g., ESPN, NFL, MLB, etc.) such that winning wagers may be automatically identified via identifier component 1360 at act 1960. Alternatively, act 1950 may involve receiving input from the creator of the game regarding the event, wherein identifier component 1360 is configured to identify winners at act 1960 according this input. Process 1900 then concludes at act 1970 with results of the pick'em game being disseminated to the participating players via communication component 1330.

A customized “pool” game may also be generated by computing device 1300 via process 1900. In an aspect of the disclosure, a customized pool game may be defined as a social media driven game in which at least two players predict the outcome of multiple events. For instance, a user may wish to create a customized pool game where players of the pool game predict the outcome of multiple football games (e.g., “all NFL games for Week 9”). Within such embodiment, the monitoring of events performed at act 1950 would now comprise monitoring multiple football games, and the identification of winners performed at act 1960 would now comprise determining which player accurately predicted the most games.

It is further contemplated that computing device 1300 may be configured to generate any of several customized pick'em and/or pool game variations. For instance, rather than predicting the outcome of events in which one entity competes against another entity, the aspects disclosed herein may be applied to events where multiple participants are competing against each other (e.g., golf, racing, tournaments, etc.). It should be further appreciated that such events do not need to be actual sporting events. For instance, a user may wish to generate a game based on predicting which college football players get drafted highest to play professionally. Within such embodiment, each player may have a set number of draftees they may venture with (e.g., 3 college players at $5/player). Then, once all players of the game have been confirmed, assignment component 1350 may be configured to randomly assign the draftees to the players and lock in their corresponding picks for the draft. Each player may then have a score based off their picks and whoever has the most points wins the pool. Also, sub-games may also be incorporated wherein, for example, whoever gets the top draft pick wins a component of the game.

In another aspect, predicting the outcomes of reality television events are also contemplated. For instance, in reality television competitions where participants are sequentially voted/selected off (e.g., reality participants competing for a date, modeling contract, album deal, etc.,), each player may select a participant he/she predicts will win the competition. Within such embodiment, computing device 1300 may be configured to monitor the game in a “knockout” format, wherein players of the game are sequentially eliminated from the game if/when their corresponding reality participant is eliminated. The winner of the game is then declared to be the player who selected the reality participant winner.

Computing device 1300 may also be configured to generate customized “challenge” games via process 1900. In an aspect of the disclosure, a customized challenge game may be defined as a social media driven game in which at least two players predict the outcome of an impromptu event. As stated previously, such challenge games may include wagering on: who is the fastest from group of bar patrons to receive a phone number; whether someone could eat a number of hot peppers in a sitting, etc. Here, for most implementations, it is contemplated that computing device 1300 will rely more heavily on the game administrator for details of the event being wagered on. In an aspect, however, computing device 1300 may leverage a social networking platform in any of a plurality of ways. For instance, players may be solicited via social media, wherein results of an event may be posted by any of the players, in addition to the administrator.

In yet another aspect, any of the aforementioned game types may be aggregated to form a “super” pool game of disparate individual game types. Such a super pool could be implemented in the format of a fantasy league, wherein a season comprises participating in a plurality of game types which may be pre-determined or randomly chosen. For instance, in one embodiment, an administrator may preselect a particular set of games and their corresponding events to be used for an entire season. In another embodiment, games and their corresponding events are selected by a different player on a rotating basis (e.g., rotate each week based on the winner of the previous week). In a further embodiment, players of the league may agree to have computing device 1300 randomly choose the games and their corresponding events. In either case, computing device 1300 is configured to automatically track the performance of each player according to the respective outcomes of each event. An exemplary season may, for instance, comprise a league of players competing according to the respective outcomes of the following four games/events:

### Week 1: Squares/Football/Packers v. Vikings

(Players are assigned squares according to any of the aspects disclosed above, wherein the winner of the squares game receives a predetermined amount of points. Multiple winners are also possible, if a winner is declared for each quarter, for example.)

### Week 2: Pick'Em/Baseball/Yankees v. Red Sox

(Players select which of these two teams will win this particular game or series. A predetermined number of points are then given to each player who correctly predicted the outcome. Here, it is contemplated that a spread may also be included.)

### Week 3: Challenge/Running/10 k Run

(Players participate in a 10k run where the winner receives points. Instead of a single winner, multiple winners may also be declared. For instance, the top three runners may receive points.)

### Week 4: Pool/Football/NFL Week 5

(Players predict who will win each NFL game for this particular week. Points could then be awarded according to which players predicted the most number of games correctly, or points may be awarded to every player for each correctly predicted game).

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

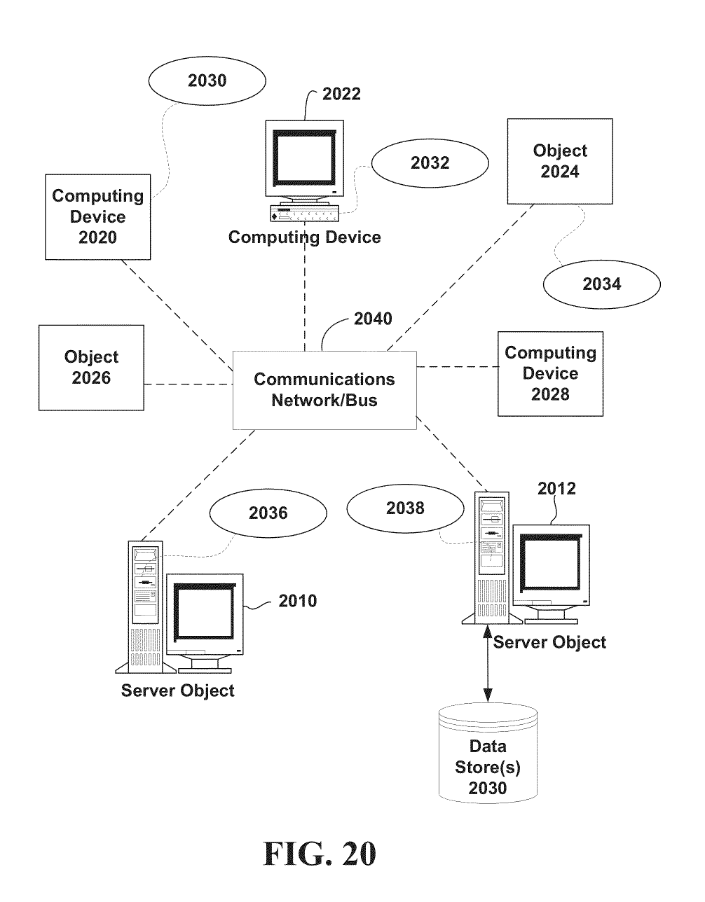

FIG. 20 provides a non-limiting schematic diagram of an exemplary networked or distributed computing environment. The distributed computing environment comprises computing objects or devices 2010, 2012, etc. and computing objects or devices 2020, 2022, 2024, 2026, 2028, etc., which may include programs, methods, data stores, programmable logic, etc., as represented by applications 2030, 2032, 2034, 2036, 2038. It can be appreciated that computing objects or devices 2010, 2012, etc. and computing objects or devices 2020, 2022, 2024, 2026, 2028, etc. may comprise different devices, such as PDAs (personal digital assistants), audio/video devices, mobile phones, MP3 players, laptops, etc.

Each computing object or device 2010, 2012, etc. and computing objects or devices 2020, 2022, 2024, 2026, 2028, etc. can communicate with one or more other computing objects or devices 2010, 2012, etc. and computing objects or devices 2020, 2022, 2024, 2026, 2028, etc. by way of the communications network 2040, either directly or indirectly. Even though illustrated as a single element in FIG. 20, network 2040 may comprise other computing objects and computing devices that provide services to the system of FIG. 20, and/or may represent multiple interconnected networks, which are not shown. Each computing object or device 2010, 2012, etc. or 2020, 2022, 2024, 2026, 2028, etc. can also contain an application, such as applications 2030, 2032, 2034, 2036, 2038, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 20, as a non-limiting example, computing objects or devices 2020, 2022, 2024, 2026, 2028, etc. can be thought of as clients and computing objects or devices 2010, 2012, etc. can be thought of as servers where computing objects or devices 2010, 2012, etc. provide data services, such as receiving data from computing objects or devices 2020, 2022, 2024, 2026, 2028, etc., storing of data, processing of data, transmitting data to computing objects or devices 2020, 2022, 2024, 2026, 2028, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 2040 is the Internet, for example, the computing objects or devices 2010, 2012, etc. can be Web servers with which the computing objects or devices 2020, 2022, 2024, 2026, 2028, etc. communicate via any of a number of known protocols, such as HTTP. As mentioned, computing objects or devices 2010, 2012, etc. may also serve as computing objects or devices 2020, 2022, 2024, 2026, 2028, etc., or vice versa, as may be characteristic of a distributed computing environment.

### Exemplary Computing Device

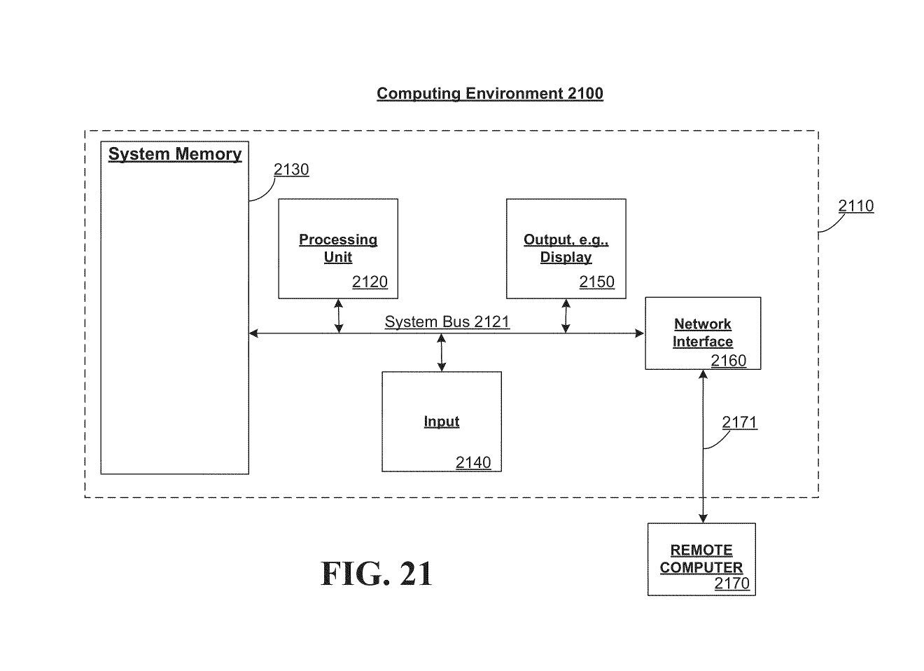

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 21 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 21 thus illustrates an example of a suitable computing system environment 2100 in which one or more of the embodiments may be implemented, although as made clear above, the computing system environment 2100 is only one example of a suitable computing environment and is not intended to suggest any limitation as to the scope of use or functionality of any of the embodiments. The computing environment 2100 is not to be interpreted as having any dependency or requirement relating to any one or combination of components illustrated in the exemplary operating environment 2100.

With reference to FIG. 21, an exemplary remote device for implementing one or more embodiments herein can include a general purpose computing device in the form of a handheld computer 2110. Components of handheld computer 2110 may include, but are not limited to, a processing unit 2120, a system memory 2130, and a system bus 2121 that couples various system components including the system memory to the processing unit 2120.

Computer 2110 typically includes a variety of computer readable media and can be any available media that can be accessed by computer 2110. The system memory 2130 may include computer storage media in the form of volatile and/or nonvolatile memory such as read only memory (ROM) and/or random access memory (RAM). By way of example, and not limitation, memory 2130 may also include an operating system, application programs, other program modules, and program data.

A user may enter commands and information into the computer 2110 through input devices 2140 A monitor or other type of display device is also connected to the system bus 2121 via an interface, such as output interface 2150. In addition to a monitor, computers may also include other peripheral output devices such as speakers and a printer, which may be connected through output interface 2150.

The computer 2110 may operate in a networked or distributed environment using logical connections to one or more other remote computers, such as remote computer 2170. The remote computer 2170 may be a personal computer, a server, a router, a network PC, a peer device or other common network node, or any other remote media consumption or transmission device, and may include any or all of the elements described above relative to the computer 2110. The logical connections depicted in FIG. 21 include a network 2171, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. A method, comprising:
receiving customization data corresponding to a squares game associated with an event, the customization data including desired dimensions of the squares game and desired parameters of the squares game;
automating generation of a digital grid based on the customization data, wherein the automating comprises generating the digital grid according to the desired dimensions, and wherein the automating comprises designating row values and column values according to the desired parameters, the row values corresponding to a first desired event parameter, and the column values corresponding to a second desired event parameter;
assigning coordinates within the digital grid to players of the squares game, wherein each of the coordinates respectively correspond to a potential outcome of the event; and
determining at least one winning coordinate within the digital grid, the at least one winning coordinate corresponding to an actual outcome of the event.

2. The method according to claim 1, wherein the event comprises a sporting event between a first entity and a second entity.

3. The method according to claim 2, wherein at least one of the first desired event parameter or the second desired event parameter corresponds to a scoring aspect of the event.

4. The method according to claim 3, the first desired event parameter associated with a score of the first entity, and the second desired event parameter associated with a score of the second entity.

5. The method according to claim 2, wherein at least one of the first desired event parameter or the second desired event parameter corresponds to a timing aspect of the event.

6. The method according to claim 5, wherein one of the first desired event parameter or the second desired event parameter corresponds to the timing aspect of the event, and wherein another one of the first desired event parameter or the second desired event parameter corresponds to an identification of the first entity and the second entity.

7. The method according to claim 5, wherein the first desired event parameter corresponds to a first timing aspect of the event, and wherein the second desired event parameter corresponds to a second timing aspect of the event.

8. A computer-readable storage medium, comprising:
a memory component configured to store computer-readable instructions, the computer-readable instructions including instructions for performing the following acts:
receiving customization data corresponding to a squares game associated with an event, the customization data including desired dimensions of the squares game and desired parameters of the squares game;
automating generation of a digital grid based on the customization data, wherein the automating comprises generating the digital grid according to the desired dimensions, and wherein the automating comprises designating row values and column values according to the desired parameters, the row values corresponding to a first desired event parameter, and the column values corresponding to a second desired event parameter;
assigning coordinates within the digital grid to players of the squares game, wherein each of the coordinates respectively correspond to a potential outcome of the event; and
determining at least one winning coordinate within the digital grid, the at least one winning coordinate corresponding to an actual outcome of the event.

9. The computer-readable storage medium of claim 8, the acts further comprising soliciting a pool of candidate players to participate in the squares game.

10. The computer-readable storage medium of claim 8, the acts further comprising monitoring a number of coordinates assigned to players.

11. The computer-readable storage medium of claim 10, the acts further comprising indicating when a maximum number of coordinate assignments has been reached.

12. The computer-readable storage medium of claim 8, wherein the assigning comprises a random assignment of coordinates to players.

13. The computer-readable storage medium of claim 8, wherein the event comprises a performance of a single competitor in a sporting event, and wherein at least one of the first desired event parameter or the second desired event parameter corresponds to a statistical aspect of the performance by the single competitor in the sporting event.

14. The computer-readable storage medium of claim 8, the determining further comprising retrieving event updates from an auxiliary device.

15. A computing device, comprising:
a memory having computer executable components stored thereon; and
a processor communicatively coupled to the memory, the processor configured to execute the computer executable components, the computer executable components comprising:
a communication component configured to receive customization data corresponding to a squares game associated with an event, the customization data including desired dimensions of the squares game and desired parameters of the squares game;
an automation component configured to facilitate automating generation of a digital grid based on the customization data, wherein the automating comprises generating the digital grid according to the desired dimensions, and wherein the automating comprises designating row values and column values according to the desired parameters, the row values corresponding to a first desired event parameter, and the column values corresponding to a second desired event parameter;
an assignment component configured to assign coordinates within the digital grid to players of the squares game, wherein each of the coordinates respectively correspond to a potential outcome of the event; and
an identification component configured to determine at least one winning coordinate within the digital grid, the at least one winning coordinate corresponding to an actual outcome of the event.

16. The computing device according to claim 15, wherein the communication component is further configured to disseminate game results to the players of the squares game.

17. The computing device according to claim 15, wherein the communication component is further configured to solicit a pool of candidate players to participate in the squares game.

18. The computing device according to claim 15, wherein the communication component is configured to notify the players of the squares game of corresponding coordinate assignments prior to the event.

19. The computing device according to claim 15, wherein the assignment component is configured to randomly assign coordinates to players.

20. The computing device according to claim 18, wherein the automation component is configured to generate a digital grid having an odd number of playable squares.
